(19) United States
(12) Patent Application Publication
(10) Pub. No.: US 2021/0400129 A1
(43) Pub. Date: Dec. 23, 2021

(54) MOBILE TERMINAL

(71) Applicant: LG ELECTRONICS INC., Seoul (KR)

(72) Inventors: Hongjo SHIM, Seoul (KR); Hyunwoo KIM, Seoul (KR)

(73) Assignee: LG ELECTRONICS INC., Seoul (KR)

(21) Appl. No.: 17/004,418

(22) Filed: Aug. 27, 2020

(30) Foreign Application Priority Data
Jun. 19, 2020 (KR) PCT/KR2020/007954

(51) Int. Cl. H04M 1/02; G06F 3/043

(52) U.S. Cl. CPC H04M 1/0266; G06F 2203/04105; H04M 2250/22; G06F 3/043

(57) ABSTRACT

A mobile terminal including a casing; a flexible display unit including a front surface located on a front surface of the casing and a side surface extending from the front surface of the display unit and located on a side surface of the casing; a window covering the display unit; and a user input unit including a force sensor for detecting a pressing force and being seated in a sensor seating portion located on the side surface of the casing and disposed to overlap the side surface of the display unit.

### CROSS-REFERENCE TO RELATED APPLICATION

Pursuant to 35 U.S.C. § 119, this application claims the benefit of an earlier filing date and priority to PCT International Application No. PCT/KR2020/007954 filed on Jun. 19, 2020, the contents of which are incorporated by reference herein in its entirety.

### BACKGROUND OF THE INVENTION

### Field of the Invention

The present disclosure relates to a mobile terminal including a display unit extending to a side surface that has a side surface user input unit having excellent sensitivity.

### Discussion of the Related Art

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As such functions become more diversified, the mobile terminal can support more complicated functions such as capturing images or video, reproducing music or video files, playing games, receiving broadcast signals, and the like. By comprehensively and collectively implementing such functions, the mobile terminal may be embodied in the form of a multimedia player or device.

As a multimedia function of the mobile terminal is strengthened, an area occupied by a display unit is gradually increasing. Recently, as a flexible display unit that may be bent can be mounted on the mobile terminal, the display unit can be extended to a side surface in addition to a front surface of the mobile terminal. When the display unit extends to the side surface while forming a curved surface, a display unit that is viewed to have a length greater than an actual extended length may be implemented.

However, there is a problem in that a user input unit positioned on the side surface of the mobile terminal and the display unit extending in a lateral direction overlap, so that implementation of the user input unit is difficult.

### SUMMARY OF THE INVENTION

Accordingly, one aspect of the present disclosure is to provide a mobile terminal including a user input unit overlapping with a display unit extended to a side surface of the mobile terminal.

Another aspect of the present disclosure provides a mobile terminal including a casing, a display unit including a front surface located on a front surface of the casing and a side surface extending from the front surface of the display unit and located on a side surface of the casing, a window for covering the display unit, and a user input unit located on the side surface of the casing and disposed overlapping the display unit.

In one implementation, the user input unit may be located between the display unit and the casing.

In one implementation, the casing may include a first casing for seating the front surface of the display unit thereon, a second casing for seating the side surface of the display unit thereon, and a sensor seating portion defined at a position corresponding to the user input unit of the second casing, wherein the user input unit may include a force sensor located in the sensor seating portion.

In one implementation, the display unit may include a panel for outputting an image thereon and a metal layer located on an inner surface of the panel, wherein the force sensor may be attached to the second casing and may be disposed to define a gap with the metal layer.

In one implementation, the force sensor may include a base substrate seated on the second casing, and a sensing coil formed on the base substrate, wherein when a size of the gap defined between the metal layer and the force sensor changes, the user input unit may recognize a user input based on a counter electromotive force flowing through the sensing coil.

In one implementation, the mobile terminal may further include an elastic member located in the gap between the metal layer and the force sensor.

In one implementation, the user input unit may include the force sensor attached to a portion inward of the side surface of the display unit and disposed to define a gap together with the second casing.

In one implementation, the force sensor may include a flexible substrate, and a strain gauge located on a surface of the flexible substrate and including a plurality of elements whose resistance values change when the flexible substrate is bent, wherein the user input unit may sense a bending deformation of the side surface of the display unit to recognize a user input.

In one implementation, the mobile terminal may further include an elastic member located in the gap between the force sensor and the second casing.

In one implementation, the casing may include a first casing for seating the front surface of the display unit thereon, and a second casing for seating the side surface of the display unit thereon, wherein the user input unit may include a force sensor located in the second casing, and a touch sensor disposed in overlap with the display unit, wherein when a touch input is sensed by the touch sensor overlapping with the side surface of the display unit, a user input may be recognized based on a signal sensed by the force sensor.

In one implementation, the casing may include a first casing for seating the front surface of the display unit thereon, and a second casing for seating the side surface of the display unit thereon, wherein the user input unit may include a force sensor located in the second casing, and an ultrasonic sensor disposed in parallel with the force sensor, wherein when a change of a signal is sensed by the ultrasonic sensor, a user input may be recognized based on a signal sensed by the force sensor.

In one implementation, the force sensor may include a strain gauge including a plurality of elements arranged around the ultrasonic sensor.

Another aspect of the present disclosure provides a mobile terminal including a first casing directed in a forward direction, a second casing directed in a lateral direction, a third casing directed in a rearward direction, a display unit including a front surface located on a front surface of the first casing and a side surface extending from the front surface of the display unit and located on a side surface of the second casing, a window for covering the display unit, and a user input unit coupled to the first casing or the third casing, wherein the user input unit includes a base substrate, and a strain gauge located on a surface of the base substrate and including a plurality of elements arranged in a horizontal direction.

Another aspect of the present disclosure provides a mobile terminal including a first casing directed in a forward direction, a second casing directed in a lateral direction and including an exposed portion at least partially exposed to an outside, a display unit including a front surface located on a front surface of the first casing and a side surface extending from the front surface of the display unit and located on a side surface of the second casing, a window for covering the display unit, and a user input unit coupled to the second casing to sense a user input at the exposed portion, wherein the user input unit includes an ultrasonic sensor including a transmitter for outputting an ultrasonic wave to the exposed portion and a receiver for sensing the ultrasonic wave reflected from the exposed portion.

In one implementation, the second casing may include an inclined portion including a surface parallel to the exposed portion, wherein the ultrasonic sensor may be mounted on the inclined portion.

The mobile terminal of the present disclosure may extend the display unit to the side surface of the mobile terminal, thereby providing a wider screen.

Even when the display unit is extended to the side surface of the mobile terminal, the user input unit may be disposed on the side surface of the mobile terminal, thereby realizing a larger screen while maintaining a performance of the mobile terminal.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a mobile terminal in accordance with the present disclosure;

FIGS. 2 and 3 are respectively perspective views of a front surface and a rear surface of a mobile terminal in accordance with the present disclosure;

FIG. 4 illustrates cross-sectional views of a side surface of a mobile terminal;

FIG. 5 is a perspective view illustrating an example of a user input unit of a mobile terminal;

FIG. 6 illustrates perspective views of an example of a force sensor of a user input unit;

FIGS. 7 and 8 are perspective views illustrating another example of a force sensor of a user input unit;

FIGS. 9 and 10 are views illustrating another embodiment of a force sensor of a user input unit;

FIGS. 11 and 12 are respectively a diagram illustrating an embodiment of an ultrasonic sensor of a user input unit and a graph illustrating a performance thereof; and

FIG. 13 is view illustrating another embodiment of a user input unit.

### DETAILED DESCRIPTION OF THE EMBODIMENTS

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another. It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

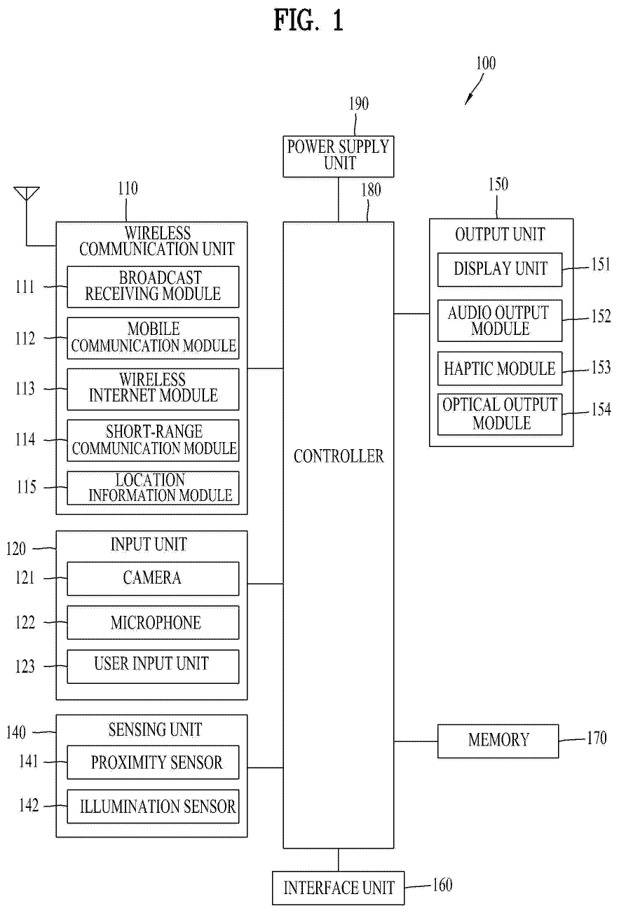

FIG. 1 is a block diagram of a mobile terminal in accordance with the present disclosure. The mobile terminal 100 is shown having components such as a wireless communication unit 110, an input unit 120, a sensing unit 140, an output unit 150, an interface unit 160, a memory 170, a controller 180, and a power supply unit 190. Referring now to FIG. 1, the mobile terminal 100 is shown having wireless communication unit 110 configured with several commonly implemented components. It is understood that implementing all of the illustrated components is not a requirement, and that greater or fewer components may alternatively be implemented.

More specifically, the wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof

The sensing unit 140 is typically implemented using one or more sensors configured to sense internal information of the mobile terminal, the surrounding environment of the mobile terminal, user information, and the like. For example—the sensing unit 140 may alternatively or additionally include other types of sensors or devices, such as a proximity sensor 141 and an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output, or activating application programs stored in the memory 170.

To drive the application programs stored in the memory 170, the controller 180 may be implemented to control a predetermined number of the components mentioned above in reference with FIG. 1. Moreover, the controller 180 may be implemented to combinedly operate two or more of the components provided in the mobile terminal 100 to drive the application programs.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Some or more of the components may be operated cooperatively to embody an operation, control or a control method of the mobile terminal in accordance with embodiments of the present disclosure. Also, the operation, control or control method of the mobile terminal may be realized on the mobile terminal by driving of one or more application problems stored in the memory 170.

Hereinafter, referring to FIG. 1, the components mentioned above will be described in detail before describing the various embodiments which are realized by the mobile terminal 100 in accordance with the present disclosure.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE) , LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sensing unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches include a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor. Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 may be provided with the power supplied by an external power source and the power supplied therein under the control of the controller 180 so as to supply the needed power to each of the components. The power supply unit 190 may include a battery. The battery may be a built-in type which is rechargeable and detachably loaded in the terminal to be charged.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance. Various embodiments described herein may be implemented in a computer-readable medium, a machine-readable medium, or similar medium using, for example, software, hardware, or any combination thereof.

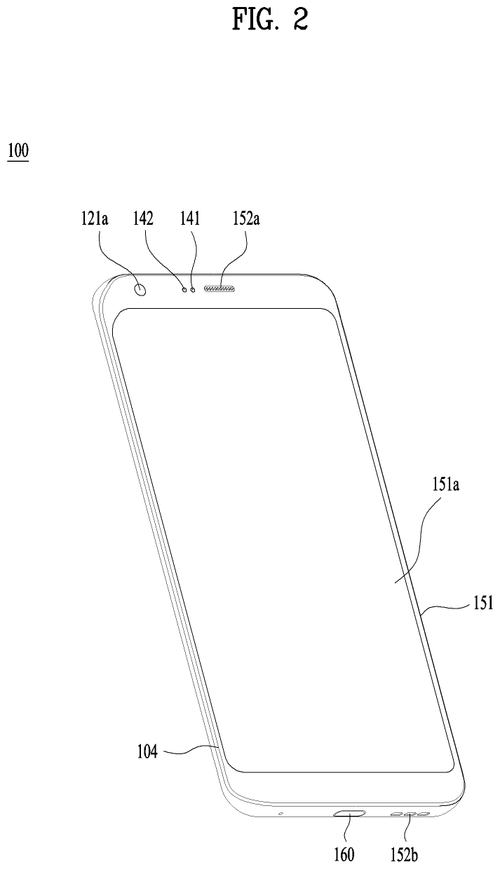

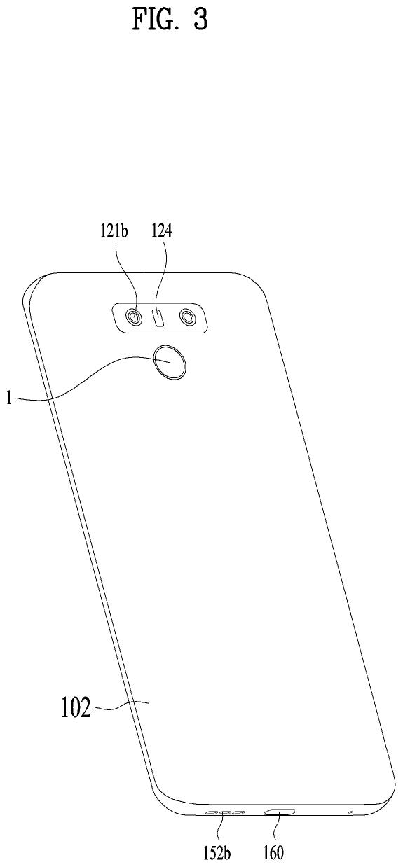

Referring now to FIGS. 2 and 3, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well. Here, the terminal body may be understood to refer to the concept of this bore a mobile terminal 100 to at least one of the aggregate.

The mobile terminal 100 includes a casing (for example, a frame, a housing, a cover, and the like) forming an exterior of the mobile terminal 100. Various parts are mounted inside the casing, and the display unit 151 is disposed on a front surface of the casing to output information. The display unit may be located on a portion of a front surface of a body of the mobile terminal or may be located to cover an entirety of the front surface of the body of the mobile terminal. Recently, as a size of the display unit is increased, the display unit may cover the entirety of the front surface of the body and further extend to a side surface of the body.

The display unit may include a front surface directed in a forward direction and side surfaces directed in a lateral direction. The side surfaces may be respectively formed only on both sides of the mobile terminal in one direction, and may be respectively arranged on both sides of the mobile terminal in a left and right direction as shown in FIG. 2. The front surface and the side surfaces of the display unit may be connected to each other while forming a curved surface.

A window 151a may form the exterior of the mobile terminal while covering the display unit. The window 151a may be located up to the side surface of the mobile terminal to cover an entirety of the display unit and may be formed in a U-shape to cover all the front surface and the side surfaces of the display unit. The window 151a may include a curved surface corresponding to the continuous curved surface of the front surface and the side surfaces of the display unit.

A portion of the casing not covered by the window 151a may be exposed to the outside to form the exterior of the mobile terminal together with the window 151a. A rear surface cover 105 forming a rear surface exterior of the mobile terminal may be further included and the rear surface cover 105 may contain a glass material like the window 151a. The rear surface cover 105 may also extend in the lateral direction while forming a curved surface like the window on the front surface.

The battery, a main board, the audio output module 152, the camera 121, and the like may be arranged inside the casing. In addition, the camera 121a, the proximity sensor 141, and the like may be exposed in the forward direction. In one example, the rear surface cover 105 may include an opening defined therein for exposing the camera 121b or the audio output module 152b to the outside. A camera window for covering the opening may be included.

Such casings 101 and 105 may be formed by performing injection molding on a synthetic resin or may be made of metal, for example, stainless steel (STS), aluminum (Al), titanium (Ti), and the like.

Unlike the above example in which the plurality of casings define an inner space for accommodating various electronic components therein, the mobile terminal 100 may be formed such that one casing defines the inner space. In this case, a mobile terminal 100 of a unibody in which the synthetic resin or the metal is continuously formed from the side surface to the rear surface may be implemented. In one example, the mobile terminal 100 may include a waterproof portion (not shown) that prevents water from penetrating into the terminal body.

It will be described for the mobile terminal as shown in FIGS. 2 and 3. The display unit 151, the first audio output module 152a, the proximity sensor 141, an illumination sensor 142, the optical output module 154, the first camera 121a and the first manipulation unit 123a are arranged in front surface of the terminal body, the second manipulation unit 123b, the microphone 122 and interface unit 160 are arranged in side surface of the terminal body, and the second audio output modules 152b and the second camera 121b are arranged in rear surface of the terminal body.

It is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1). Therefore, the touch screen may replace at least some of the functions of the first manipulation unit 123a.

The first audio output module 152a may be implemented in the form of a speaker to output voice audio, alarm sounds, multimedia audio reproduction, and the like. The window 151a of the display unit 151 will typically include an aperture to permit audio generated by the first audio output module 152a to pass. One alternative is to allow audio to be released along an assembly gap between the structural bodies (for example, a gap between the window 151a and the case). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 2 illustrates the first manipulation unit 123a as a touch key, but possible alternatives include a mechanical key, a push key, a touch key, and combinations thereof. Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

A flash 124 is shown located adjacent to the second camera 121b. When an image of a subject is captured with the camera 121b, the flash 124 may illuminate the subject. The second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 (see FIG. 1) may be retractable into the terminal body. Alternatively, an antenna may be formed using a film attached to an inner surface of the rear cover, or a case that includes a conductive material.

A power supply unit 190 for supplying power to the mobile terminal 100 may include a battery, which is mounted in the terminal body or detachably coupled to an outside of the terminal body. The battery may receive power via a power source cable connected to the interface unit 160. Also, the battery can be recharged in a wireless manner using a wireless charger. Wireless charging may be implemented by magnetic induction or electromagnetic resonance.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

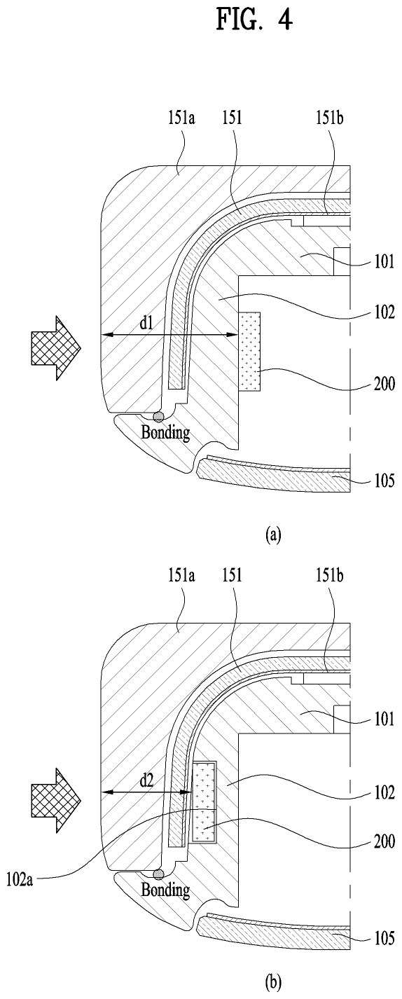

Next, FIG. 4 is a cross-sectional view of the mobile terminal 100. The casing of the mobile terminal 100 may include a first casing 101 directed in the forward direction and a second casing 102 directed in the lateral direction. The first casing 101 and the second casing 102 may be integrally formed and define a mounting space for the electronic components together with the rear surface cover 105 that covers the rear surface.

The display unit 151 can be coupled to the first casing 101 and the second casing 102, and be located on the side surface of the mobile terminal 100 as well as the front surface of the mobile terminal 100. The display unit 151 also includes the front surface overlapping the first casing and the side surfaces overlapping the second casing. The front surface and the side surfaces of the display unit 151 thus form a continuous curved surface. In addition, the display unit 151 may include a flexible display such that the front surface and the side surfaces are arranged to form the curved surface.

In more detail, the flexible display is made on thin and flexible substrate that can bend like paper while maintaining characteristics of an existing flat panel display. An organic light emitting diode (OLED) display is an example of the flexible display. Further, the OLED display can implemented thinly because there is no backlight, so that the OLED display can be bent.

Although the front surface of the display unit 151 of the present disclosure forms a flat surface, the front surface may be curved while forming a curved surface for connection with the side surfaces. Also, the first casing 101 and the second casing 102 may be formed as one body while forming the curved surface corresponding to the display unit 151.

However, as the display unit 151 is located on the side surface of the mobile terminal 100, there is a problem that the display unit 151 overlaps a user input unit 200 located on the side surface. Thus, the mobile terminal 100 having a design in which the display unit 151 extends to the side surface of the mobile terminal 100 must omit the user input unit 200 positioned on the side surface or dispose the user input unit 200 to overlap the display unit 151. Because the side surface of the mobile terminal is covered by the display unit 151, a conventional user input unit 200 in a form of using a dome button is difficult to implement because there is no mounting space.

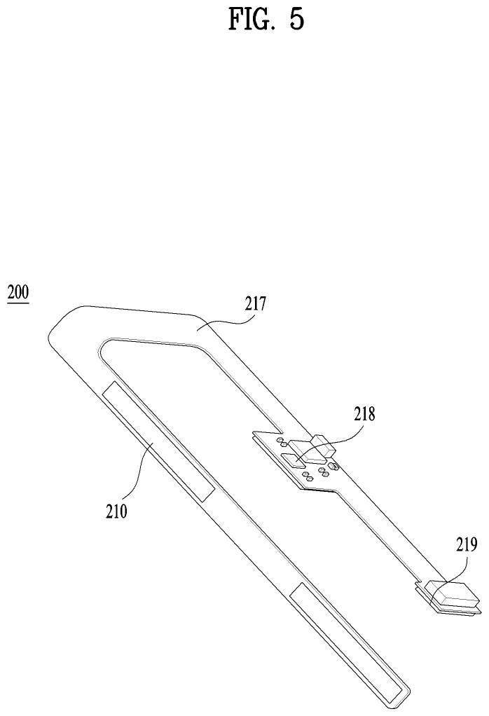

A force sensor 210 (FIG. 5) may be used to implement the user input unit 200 disposed to overlap the display unit 151. The force sensor 210 is also referred to as a force touch, and operates by recognizing a pressing force. As a sensor that generates an electrical signal in response to a minute mechanical change, the force sensor 210 can sense a change in a range from a few to tens of ums on an attached surface. Also, the force sensor 210 does not need to be exposed directly to the outside, so that the force sensor 210 can be located on an inner surface of the display unit 151.

However, as shown in (a) of FIG. 4, when the force sensor 210 is located inside the second casing 102, a user's input is transmitted through a plurality of layered structures, such as the window 151a, the display unit 151, and the second casing 102, so that it may be difficult to sense an accurate input. Thus, according to an embodiment of the present invention and to increase accuracy, as shown in (b) in FIG. 4, a sensor seating portion 102a is defined in a face of the second casing 102 facing the display unit 151 and the force sensor 210 is disposed inside the sensor seating portion 102a. The sensor seating portion 102a may be implemented in a concavely engraved form in the surface of the second casing 102 facing the display unit 151, which has an advantage in that a distance d2 from an outer surface to the force sensor 210 in (b) in FIG. 4 is smaller than a distance d1 from the outer surface to the force sensor 210 in (a) in FIG. 4.

Next, FIG. 5 is a perspective view illustrating an example of the user input unit 200 including the force sensor 210 in FIG. 4. The user input unit 200 may include a flexible substrate for transmitting the change sensed by the force sensor 210 to the controller. A plurality of force sensors 210 may also be arranged on one flexible substrate to receive a plurality of user inputs. A pair of force sensors 210 are arranged side by side as shown in FIG. 5 for volume adjustment.

Further, a portion where the force sensor 210 may be located is between the second casing 102 and the display unit 151. A flexible substrate 217 may penetrate or bypass the second casing 102 to extend inward of the mobile terminal 100. In addition, a connector 219 connected to the controller 180 may be disposed at an end of the flexible substrate 217. A circuitry 218 for processing the signal from the force sensor 210 may also be included.

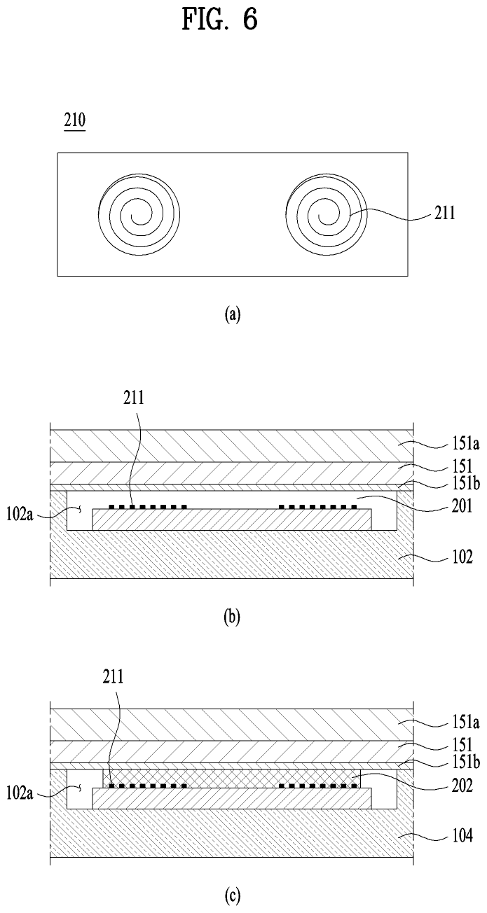

FIG. 6 illustrates views of an example of the force sensor 210. (a) in FIG. 6 is a plan view of the force sensor 210, and (b) and (c) in FIG. 6 are cross-sectional views illustrating states in which the force sensor 210 is seated in the sensor seating portion 102a. The force sensor 210 in the present embodiment is the force sensor 210 implemented using an induced current principle. When a distance between a metal layer and a sensing coil 211 is changed, a current flows through the sensing coil 211, an eddy current is generated and a pressure is sensed through such current change.

In addition, the force sensor 210 includes a base substrate and the sensing coil 211, is attached to the sensor seating portion 102a, and is disposed while defining a predetermined gap 201 with the display unit 151. The force sensor 210 including the sensing coil 211 can recognize the user input using a principle in which an induced electromotive force is generated on the coil 211 when the distance between a metal material and the sensing coil 211 changes.

As shown in (b) in FIG. 6, the display unit 151 may include a display panel on which the information is output and a metal plate 151b on a rear surface of the display panel. The display panel may use the organic light emitting diode display and may be implemented in the form of the thin film capable of being bent because no backlight is required. In order to secure a rigidity of the thin display panel, the thin metal plate 151b may be coupled to the rear surface of the display panel, and the metal plate 151b may be bent like the display panel.

Because the gap 201 is defined between the sensing coil 211 of the force sensor 210 and the metal plate 151b located on the rear surface of the display unit 151, when the user presses the side surface of the display unit 151, a size of the gap 201 changes and the current flows on the sensing coil 211. A magnitude of the pressure can be sensed based on an intensity of the current flowing through the sensing coil 211, and pressures can be sensed as different inputs based on the magnitude of the pressure.

In order to prevent the size of the gap 201 from being changed due to an unintentional impact, an elastic member 202 can be interposed in the gap 201 between the display unit 151 and the force sensor 210 as shown in (c) in FIG. 6. The elastic member 202 is physically located between the metal plate 151b and the sensing coil 211 but needs to electrically separate the metal plate 151b and the sensing coil 211 from each other, and thus contains a non-conductive material.

A sensitivity of the force sensor 210 can also be adjusted based on an elasticity of the elastic member 202. That is, the softer the elastic member 202, the more easily the size change of the gap 201 occurs, so that the sensitivity of the force sensor 210 increases. Further, the harder the elastic member 202, the lower the sensitivity of the force sensor 210.

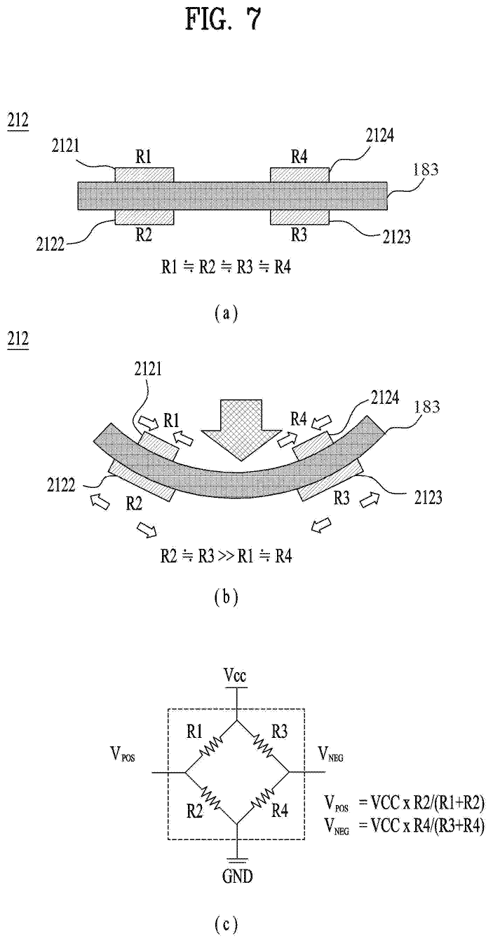

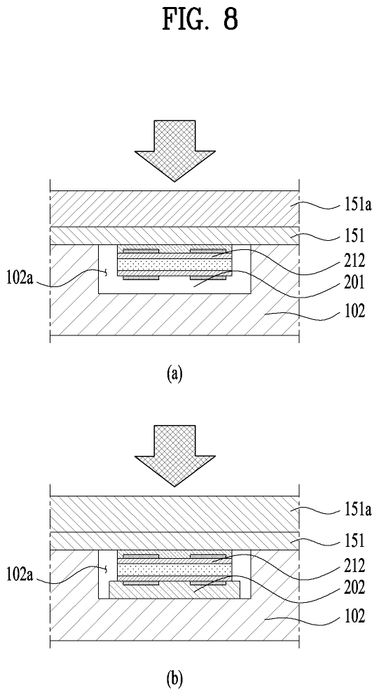

FIGS. 7 and 8 are views illustrating another embodiment of the force sensor 210 of the user input unit 200. The present embodiment is a force sensor 210 that includes a strain gauge 212. Elements 2121, 2122, 2123, and 2124 containing a metal material are included. When receiving a force, cross-sectional areas of the elements 2121, 2122, 2123, and 2124 change as the elements 2121, 2122, 2123, and 2124 are tensioned or contracted. Because a resistance value changes when a length and a cross-section size of the element change, when the user presses the force sensor 210, a shape of the element changes. The user input can be recognized through the change in the resistance of the element.

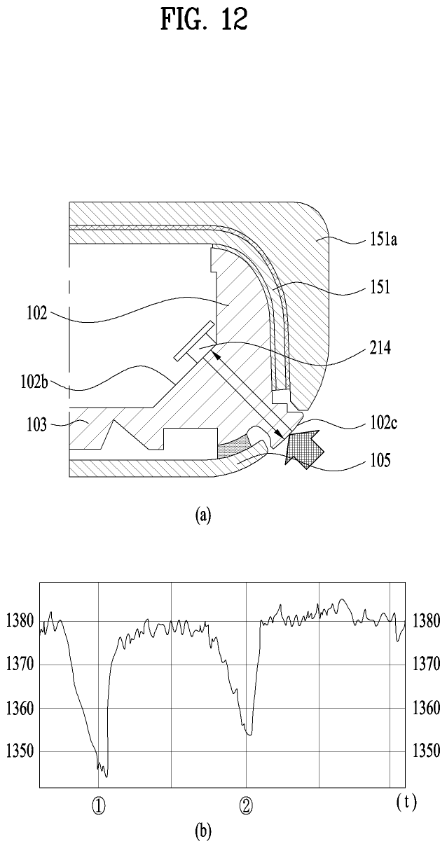

Referring to (a) in FIG. 7, in the strain gauge 212, the plurality of elements 2121, 2122, 2123, and 2124 are seated on a flexible substrate 183. When the flexible substrate 183 is bent as shown in (b) in FIG. 12, forces respectively applied to the plurality of elements 2121, 2122, 2123, and 2124 become different from each other, so that resistance values of the plurality of elements 2121, 2122, 2123, and 2124 become different from each other.

Using such property, a circuit as shown in (c) in FIG. 7 can sense a deformation based on a Vpos value and a Vneg value. When the four elements 2121, 2122, 2123, and 2124 are stably arranged as shown in (a) in FIG. 7, resistances R1 to R4 of the respective elements 2121, 2122, 2123, and 2124 are equal to each other, so that Vpos and Vneg are equal to reach other. However, when a force is applied to the flexible substrate 183 and the flexible substrate 183 is bent as shown in (b) in FIG. 7, as the resistances R1 and R4 of the first element 2121 and the fourth element 2124 become smaller and the resistances R2 and R3 of the second element 2122 and the third element 2123 become greater, the value of Vpos increases and the value of Vneg decreases. It may be seen that the flexible substrate 183 is bent in a direction different from that in (b) in FIG. 7 wen Vpos is smaller than Vneg.

As described above, the strain gauge 212 composed of the four elements 2121, 2122, 2123, and 2124 can be used, but the user input module 210 of the present disclosure does not need to sense when the flexible substrate 183 is bent in a direction opposite to that in (b) in FIG. 7, and can sense the deformation using only one or two elements to sense a pressure only.

The force sensor 210 in the present embodiment can also be located on the rear surface of the display unit 151 as shown in (a) in FIG. 8 in order for the force sensor 210 itself to be in contact with an object that is deformed. The strain gauge 212 located on the rear surface of the display unit 151 can sense the change in the resistance value of the element when the user presses the display unit 151. In the present embodiment, the gap 201 is defined between the second casing 102 and the force sensor 210, so that the display unit 151 and the strain gauge 212 are deformed when being pressed by the user.

As in the embodiment described above, the elastic member 202 positioned in the gap 201 may be further included to prevent a malfunction of the user input unit 200. As shown, the elastic member 202 is physically located between the metal plate 151b and the sensing coil 211, electrically separates the metal plate 151b and the sensing coil 211 from each other, and thus contains a non-conductive material.

Further, the sensitivity of the force sensor 210 can be adjusted based on the elasticity of the elastic member 202. That is, the softer the elastic member 202, the more easily the size change of the gap 201 occurs, so that the sensitivity of the force sensor 210 increases. Further, the harder the elastic member 202, the lower the sensitivity of the force sensor 210.

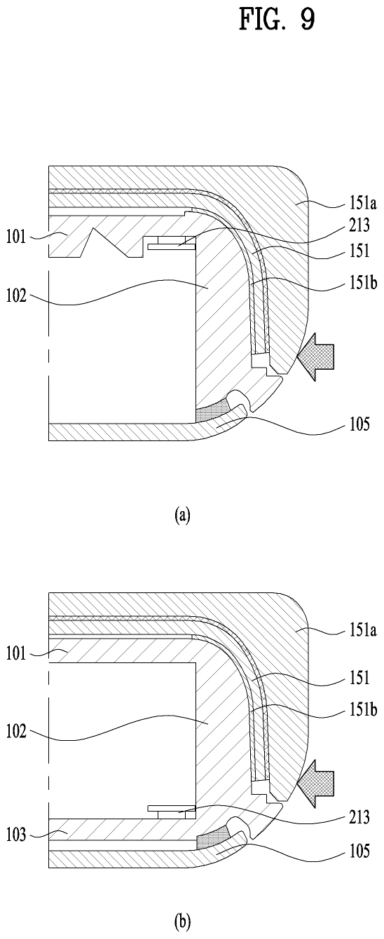

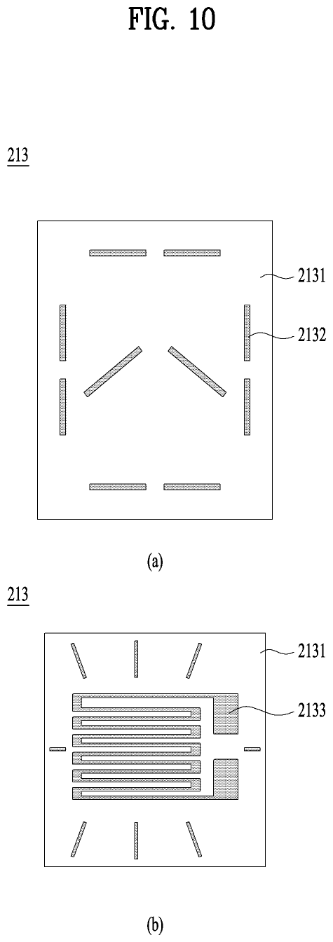

Next, FIGS. 9 and 10 are views illustrating another embodiment of a force sensor 213 of the user input unit 200. As shown, the force sensor 213 in the present embodiment is located in the first casing 101 directed in the forward direction or the third casing 103 directed in the rearward direction, not in the second casing 102.

The force sensor 213 located in the first casing 101 and the third casing 103 may use the strain gauge including a plurality of elements 2132 containing a conductive material arranged on a plane of a base substrate 2131 as shown in (a) in FIG. 10, or an element 2133 in a serpentine shape formed by a conductive strip extending in a specific direction as shown in (b) in FIG. 10 may be used. A strain gauge that senses deformation in the extending direction of the conductive strip based on arrangement directions of the plurality of elements may be used.

In addition, the second casing 102, the first casing 101, and the third casing 103 may be integrally formed. When the user presses the second casing 102, a force is transmitted to the force sensor 213 attached to the first casing 101 or the third casing 103. When being more adjacent to the portion of the second case 102 exposed to the outside, transmission of the force is easy. Thus, a sensitivity of the force sensor 213 can be higher in the embodiment in which the force sensor 213 is coupled to the third casing 103 as shown in (b) in FIG. 9 than in the embodiment in which the force sensor 213 is coupled to the first casing 101 as shown in (a) in FIG. 9.

Because the force sensor 213 can sense the deformation when the mobile terminal 100 is twisted or subjected to an impact, the force sensor 213 cannot distinguish a deformation resulted from being pressed by the user and a deformation caused by the impact from each other. In order to remove such noise, the force sensor 213 that senses deformations in a plurality of directions can be used to distinguish a force applied in the lateral direction from other forces. In particular, the strain gauge 212 is useful to sense the deformations in various directions, so that a misinput resulted from an unintentional deformation can be prevented using a plurality of elements having different arrangements and shapes.

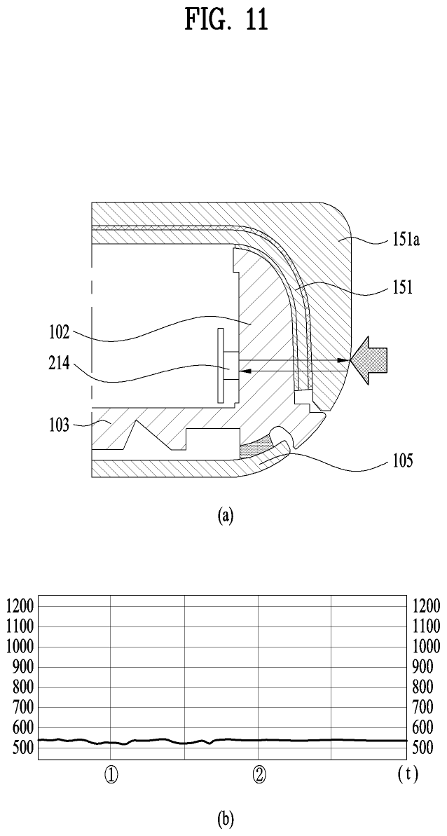

Next, FIGS. 11 and 12 are respectively a diagram illustrating an embodiment of an ultrasonic sensor of the user input unit 200 and a graph illustrating a performance thereof. In this embodiment, an ultrasonic sensor 214 includes a transmitter that transmits an ultrasonic wave and a receiver that senses the ultrasonic wave that has been reflected back, and can sense the user input through an intensity, a wavelength, and the like of the ultrasonic wave sensed by the receiver.

As shown in (a) in FIG. 11, the ultrasonic wave from the ultrasonic sensor 214 mounted in the second casing 102 penetrates the second casing 102 and passes through the layered structure of the display unit 151 to sense a touch input of the user on an outer surface of the window. However, as shown in (b) in FIG. 11, a change in the ultrasonic wave is negligible. The display unit 151 is pressed by the user at a portion where the triangular arrow is drawn in FIG. 11, but the transmitted ultrasonic wave signal is lost while passing through the structure of the plurality of layers, so that a value of the ultrasonic wave sensed by the receiver is small and there is no significant change in the value of the ultrasonic wave even when the user presses the display unit 151 as shown in (b) of FIG. 11.

Therefore, as shown in FIG. 12, the user input can be sensed using an exposed portion 102c exposed to the outside of the second casing 102. The exposed portion 102c is tactually distinguished from the window or the rear surface cover 105, so that the user can recognize the exposed portion 102c without viewing an exact position of the exposed portion 102c. In addition, because the ultrasonic wave passes through a single medium in the exposed portion 102c, the ultrasonic wave is not lost, and the wavelength of the ultrasonic wave is not distorted. Thus, as shown in (b) in FIG. 12, when the user touches the exposed portion 102c, the ultrasonic wave signal changes drastically, so that the user input is able to be recognized.

In order for the transmitted ultrasonic wave to be reflected from a user's hand and return to the receiver of the ultrasonic sensor 214, it is preferable that the exposed portion 102c to be in contact with the user's hand and the ultrasonic sensor 214 are arranged in parallel with each other. Thus, the second casing 102 may include a sensor seating portion 102b that forms an inclined surface parallel to the exposed portion inside the exposed portion.

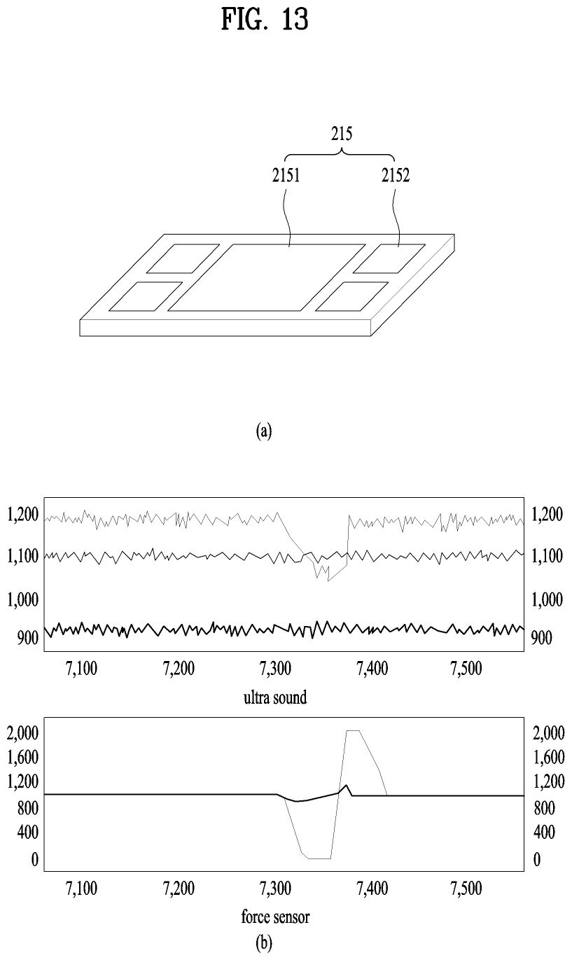

Next, FIG. 13 is a view illustrating another embodiment of the user input unit 200. The present embodiment relates to a user input unit 215 that recognizes the user input using a plurality of sensors. As shown in (a) in FIG. 13, the user input unit 215 of the present embodiment includes the ultrasonic sensor 2151 as well as the force sensor 2152. The user input can be sensed using the ultrasonic sensor 2151 and the strain gauge 2152 including a plurality of elements positioned around the ultrasonic sensor 2151.

The user input unit 215 of the present embodiment in which the strain gauge 2152 and the ultrasonic sensor 2151 are integrally formed can be mounted in the second casing 102, located inside the second casing 102 as shown in (a) in FIG. 4, and be disposed between the second casing 102 and the display unit 151. When the mobile terminal 100 is twisted or subjected to the impact, the force sensor 213 may sense the deformation regardless of the intention of the user. Alternatively, when the user input unit 200 is composed of only the ultrasonic sensor 214, an object located at a reflection position of the ultrasonic wave may be sensed as the user input by the user input unit 200.

Therefore, the present embodiment can sense a value recognized by the force sensor 2152 as a valid user input only when the change in the ultrasonic wave is recognized by the ultrasonic sensor 2151 as shown in (b) in FIG. 13. Instead of the ultrasonic sensor 214, a touch sensor may be used. The display unit 151 may include the touch sensor, or the touch sensor may be disposed to overlap the display unit 151. Only when the touch sensor senses a touch input on the side surface of the display unit 151, a deformation value of the force sensor 213 may be determined as a valid value to recognize the user input.

The display unit of the present disclosure can extend to the side surface of the mobile terminal, thereby providing a wider screen. Even when the display unit extends to the side surface of the mobile terminal, the user input unit can be disposed on the side surface of the mobile terminal, thereby realizing a large screen while maintaining a performance of the mobile terminal.

Therefore, the above detailed description should not be construed as limiting in all respects, but should be considered illustrative. The scope of the present disclosure should be determined by rational interpretation of the appended claims, and all changes within the equivalent scope of the present disclosure are included in the scope of the present disclosure.

1. A mobile terminal comprising:
a casing including a first casing directed in a forward direction and a second casing directed in a lateral direction;
a flexible display unit including a front surface located on a front surface of the first casing and a side surface extending from the front surface of the display unit and located on a side surface of the second casing;
a window covering the display unit; and
a user input unit including a force sensor for detecting a pressing force and being seated in a sensor seating portion located on the side surface of the second casing and disposed to overlap the side surface of the display unit,
wherein the display unit includes a display panel for displaying an image thereon and a metal layer located on an inner surface of the display panel,
wherein an air gap exists between the force sensor seated in the sensor seating portion and the metal layer, and
wherein the force sensor detects a pressing force when a size of the air gap changes.

2. The mobile terminal of claim 1, wherein the sensor seating portion faces the side surface of the display unit.

3. The mobile terminal of claim 2, wherein the casing includes:
wherein the sensor seating portion comprises an engraved seating portion in the second casing.

4. (canceled)

5. The mobile terminal of claim 1, further comprising:
a controller determining a user input in response to a pressing force against a side surface of the window covering the display unit overlapping with the force sensor,
wherein the force sensor includes:
a base substrate seated on the sensor seating portion of the second casing; and
a sensing coil formed on the base substrate, and
wherein the controller determines the user input based on a counter electromotive force flowing through the sensing coil when a size of the air gap changes.

6. The mobile terminal of claim 1, further comprising:
an elastic member located in the air gap between the metal layer and the force sensor.

7. The mobile terminal of claim 3, wherein the force sensor is attached to a portion inward of the side surface of the display unit and disposed to define a gap together with the second casing.

8. The mobile terminal of claim 7, further comprising:
a controller determining a user input in response to a pressing force against a side surface of the window covering the display unit overlapping with the force sensor,
wherein the force sensor includes:
a flexible substrate; and
a strain gauge located on a surface of the flexible substrate and including a plurality of elements whose resistance values change when the flexible substrate is bent, and
wherein the controller determines the user input in response to a bending deformation of the side surface of the display unit sensed by the force sensor.

9. The mobile terminal of claim 7, further comprising:
an elastic member located in the gap between the force sensor and the second casing.

10. The mobile terminal of claim 1, further comprising:
a controller determining a user input in response to a pressing force against a side surface of the window covering the display overlapping with the force sensor,
wherein the user input unit further includes:
a touch sensor overlapping with the display unit, and
wherein the controller determines the user input when a touch input is sensed by the touch sensor overlapping with the side surface of the display based on a signal sensed by the force sensor.

11. The mobile terminal of claim 1, further comprising:
a controller determining a user input in response to a pressing force against a side surface of the window covering the display unit overlapping with the force sensor,
wherein the user input unit further includes:
an ultrasonic sensor disposed in parallel with the force sensor, and
wherein the controller determines the user input when a change of a signal is sensed by the ultrasonic sensor based on a signal sensed by the force sensor.

12. The mobile terminal of claim 11, wherein the force sensor includes a strain gauge including a plurality of elements arranged around the ultrasonic sensor.

13. A mobile terminal comprising:
a first casing directed in a forward direction;
a second casing directed in a lateral direction;
a third casing directed in a rearward direction;
a display unit including a front surface located on a front surface of the first casing and a side surface extending from the front surface of the display unit and located on a side surface of the second casing;
a window covering the display unit; and
a user input unit coupled to the first casing or the third casing,
wherein the user input unit includes:
a base substrate;
a strain gauge located on a surface of the base substrate and including a plurality of conductive elements having different arrangements and shapes; and
a controller determining a user input in response to a pressing force against the second casing based on a deformation signal sensed by the strain gauge.

14. The mobile terminal of claim 13, wherein the plurality of conductive elements are arranged in a horizontal direction.

15. The mobile terminal of claim 13, wherein the plurality of conductive elements are arranged in a serpentine shape.

16. The mobile terminal of claim 13, wherein the second casing includes an exposed portion partially exposed to an outside.

17. The mobile terminal of claim 16, wherein the user input is located in the third casing and faces the first casing.

18. The mobile terminal of claim 17, wherein the user input is located in the third casing at a position adjacent to the exposed portion of the second casing.

19. A mobile terminal comprising:
a casing including a first casing directed in a forward direction, a second casing directed in a lateral direction, and an exposed portion partially exposed to an outside;
a display unit including a front surface located on a front surface of the first casing and a side surface extending from the front surface of the display unit and located on a side surface of the second casing;
a window covering the display unit;
a rear cover covering a rear surface of the mobile terminal;
an ultrasonic sensor coupled to the second casing to sense a user input at the exposed portion, and including a transmitter for transmitting an ultrasonic wave to the exposed portion and a receiver for receiving the ultrasonic wave reflected from the exposed portion; and
a controller determining a user input in response to a touching input against the exposed portion and the ultrasonic wave received by the ultrasonic sensor,
wherein the exposed portion is placed between the window and the rear cover and obliquely directed between the lateral direction to a rearward direction.

20. The mobile terminal of claim 19, wherein the second casing includes an inclined portion including a surface parallel to the exposed portion, and
wherein the ultrasonic sensor is mounted on the inclined portion.
